(19) United States
(12) Patent Application Publication
(10) Pub. No.: US 2013/0069556 A1
(43) Pub. Date: Mar. 21, 2013

(54) LIGHT-EMITTING ELEMENY DRIVER CIRCUIT

(71) Applicants: Wen-Chun Wang, Taichung City (TW); Wen-Tui Liao, Tai Chung City (TW); Tsung-Yu Wang, Taichung City (TW); Kuo-Chang Su, Tai Nan County (TW)

(72) Inventors: Wen-Chun Wang, Taichung City (TW); Wen-Tui Liao, Tai Chung City (TW); Tsung-Yu Wang, Taichung City (TW); Kuo-Chang Su, Tai Nan County (TW)

(21) Appl. No.: 13/618,636

(22) Filed: Sep. 14, 2012

(30) Foreign Application Priority Data
Sep. 19, 2011 (TW) 100133556

(51) Int. Cl. H05B 37/02; H05B 37/00

(52) U.S. Cl. 315/228; 315/240

(57) ABSTRACT

A light-emitting element driver circuit is disclosed in embodiment of the invention. The light-emitting element driver circuit includes a driver unit for generating a driving current to the light-emitting element; a data storage unit for storing a threshold voltage of the driver unit and current data signal voltage; and a control unit being controlled to be conducted during a light emitting period so that the driver unit generates a driving current in response to the threshold voltage and current data signal voltage stored in the data storage unit.

### BACKGROUND OF THE INVENTION

1. Field of the Invention

The invention relates to an electronic circuit, and more particularly, to a light-emitting element driver circuit.

2. Description of the Related Art

In a typical AMOLED (active-matrix organic light-emitting diode), the gate and the source of a driving transistor are controlled to generate a driving current to drive an EL element to emit light. The threshold voltage of the driving transistor affects the current flowing through the EL element. Since the threshold voltage of the driving transistor changes depending on manufacturing process parameters, it leads to threshold voltage deviations between pixels. Further the threshold voltage may be affected by environment factor to generate a variation over time. Thus it may cause an AMOLED display panel non-uniformity or power delivery IR drop through a flow path of the driving current to result in luminance change of an AMOLED.

### SUMMARY OF THE INVENTION

In view of the above mentioned problem, one object is to provide a light-emitting element driver circuit for compensating threshold voltage variation of a driving transistor in a pixel circuit.

According to an embodiment of the invention, a light-emitting element driver circuit includes a driver unit for generating a driving current to the light-emitting element; a data storage unit for storing a threshold voltage of the driver unit and current data signal voltage; and a control unit being controlled to be conducted during a light emitting period so that the driver unit generates a driving current in response to the threshold voltage and current data signal voltage stored in the data storage unit.

According to another embodiment of the invention, a light-emitting element driver circuit includes a light-emitting element, wherein a driving current flows through the light-emitting element; a first transistor being controlled by a first scan line signal; a second transistor being controlled by a data signal voltage to generate the driving current; a capacitor for storing the data signal voltage and a threshold voltage of the second transistor; a third transistor being controlled by a second scan line signal to receive the data signal voltage to apply the data signal voltage to a first terminal of the capacitor; a fourth transistor being controlled by a first light-emitting signal to provide the driving current of the second transistor to the light-emitting element; and a fifth transistor being controlled by a second light-emitting signal to couple the first terminal of the capacitor to a ground potential; wherein the first transistor applies the threshold voltage of the second transistor to a second terminal of the capacitor according to the first scan line signal, and the first transistor couples to the second transistor to form a diode-connected configuration to detect deviation of the threshold voltage of the second transistor.

According to another embodiment of the invention, a light-emitting element driver circuit includes: a power supply terminal for receiving a power supply voltage; a light-emitting element, wherein a driving current flows through the light-emitting element; a first transistor being controlled by a first scan line signal; a second transistor coupled to the first transistor to form a diode, wherein the second transistor includes a threshold voltage and receives a voltage difference value; a capacitor comprising a first terminal and a second terminal and storing the voltage difference value between the first terminal and the second terminal; a third transistor being controlled by a second scan line signal to receive the data signal voltage to apply the data signal voltage to the first terminal; a fourth transistor being controlled by a first light-emitting signal to supply the driving current to the light-emitting element; and a fifth transistor being controlled by a second light-emitting signal to couple the first terminal to a ground potential; wherein the first transistor applies the threshold voltage to the second terminal according to the first scan line signal, and the second transistor generates the driving current according to the voltage difference value and the voltage difference value compensates deviation of the threshold voltage of the second transistor.

According to another embodiment of the invention, a display device comprises: a plurality of gate lines; a plurality of data lines; a plurality of power lines; and a plurality of pixels each arranged in an associated gate line, data line and power line; each pixel comprising: a first transistor being controlled by a first scan line signal; a second transistor being controlled by a data signal voltage to generate the driving current, wherein the second transistor couples to the first transistor to form a diode-connected configuration; a capacitor for storing the data signal voltage; a third transistor being controlled by a second scan line signal to receive the data signal voltage to apply the data signal voltage to a first terminal of the capacitor; a fourth transistor being controlled by a first light-emitting signal to supply the driving current of the second transistor to an organic light-emitting diode; and a fifth transistor being controlled by a second light-emitting signal to couple the first terminal of the capacitor to a ground potential; wherein the first transistor applies the threshold voltage of the second transistor to a second terminal of the capacitor according to the first scan line signal, and the driving current generated by the second transistor is not related to the threshold voltage of the second transistor.

The present invention can solve problem of threshold voltage variation of the driving transistor, stabilize the driving current, and compensate power delivery IR drop through a flow path of the driving current.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic diagram illustrating an embodiment of the driver circuit.

FIG. 2A shows an exemplary circuit diagram of the driver circuit.

FIG. 2B shows a wave diagram illustrating an embodiment of the driver circuit

FIG. 2C shows an operation schematic diagram of the driver circuit.

FIG. 2D shows another operation schematic diagram of the driver circuit.

FIG. 2E shows another operation schematic diagram of the driver circuit.

FIG. 3 shows another wave diagram illustrating an embodiment of the driver circuit

FIG. 4 shows a schematic diagram illustrating another embodiment of the driver circuit for a display device.

FIG. 5A shows another exemplary circuit diagram of the driver circuit.

FIG. 5B shows another wave diagram illustrating an embodiment of the driver circuit

### DETAILED DESCRIPTION OF THE INVENTION

In this specification and the appended claims, some specific words are used to describe specific elements. It should be understood by those who are skilled in the art that some hardware manufacturer may use different names to indicate the same element. In this specification and the appended claims, elements are not differentiated by their names but their functions. As used herein and in the claims, the term “comprising” is inclusive or open-ended and does not exclude additional unrecited elements, compositional components, or method steps. Besides, the term “coupling”, when used herein and in the claims, refers to any direct or indirect connection means. Thus, if the specification describes a first device is coupled to a second device, it indicates that the first device can be directly connected (via signal connection, including electrical connection, wireless transmission, optical transmission, etc.) to the second device, or be indirectly connected to the second device via another device or connection means.

The use of the terms “a” and “an” and “the” and similar referents in the context of describing the invention are to be construed to cover both the singular and the plural, unless otherwise indicated herein or clearly contradicted by context.

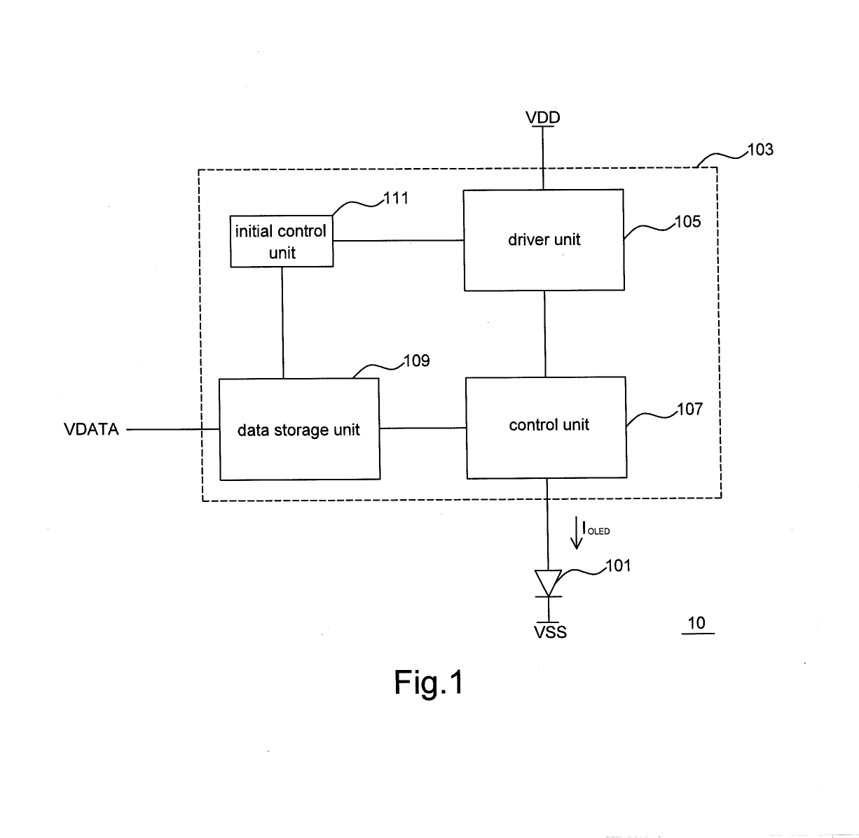

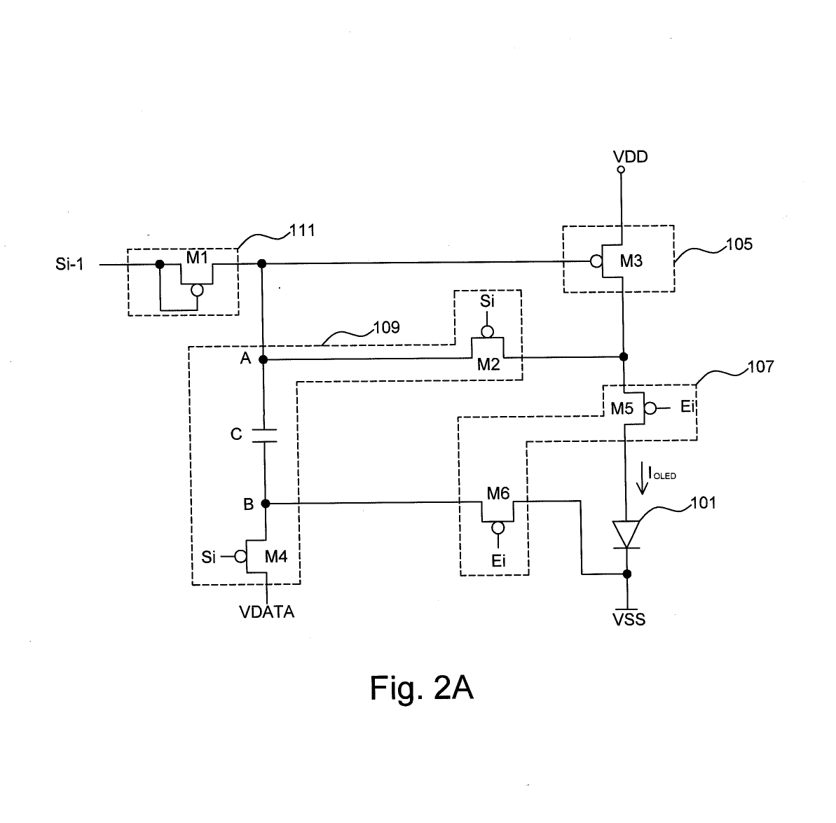

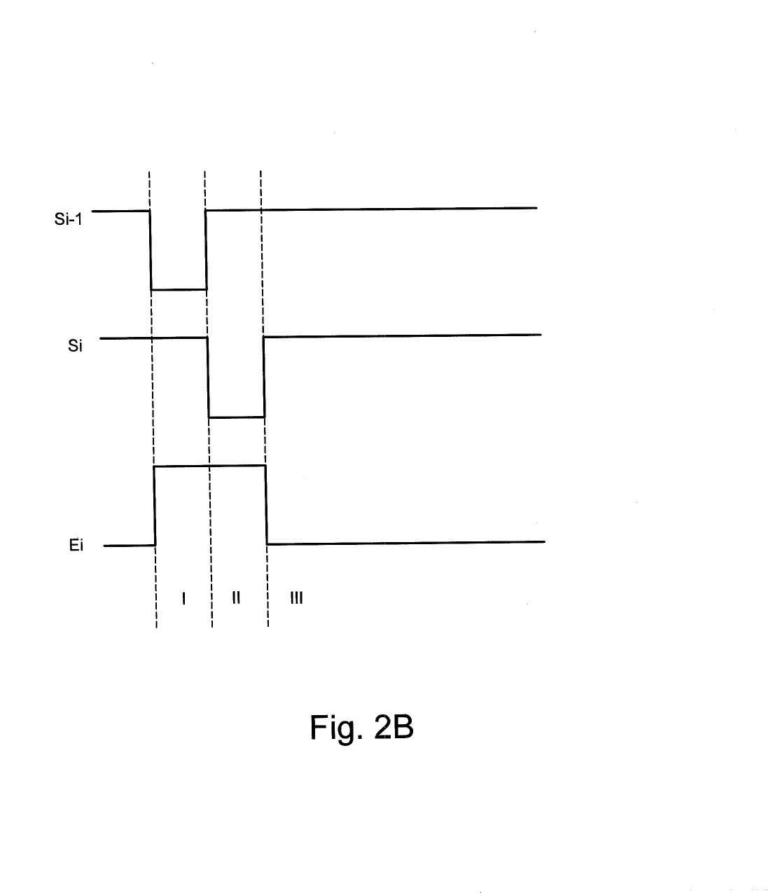

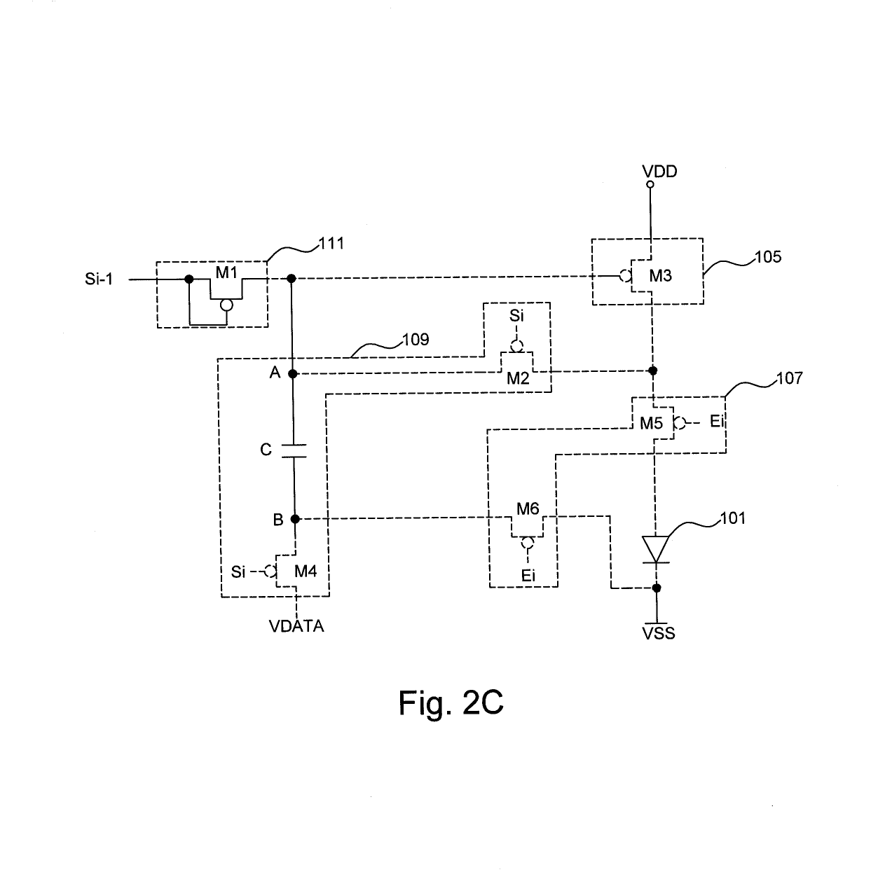

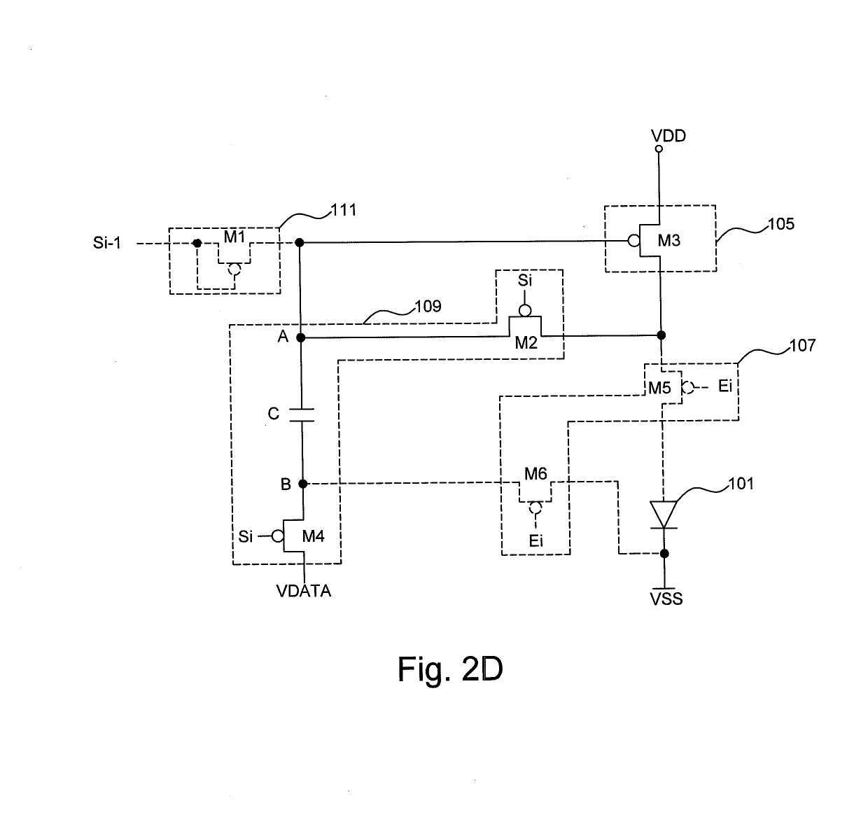

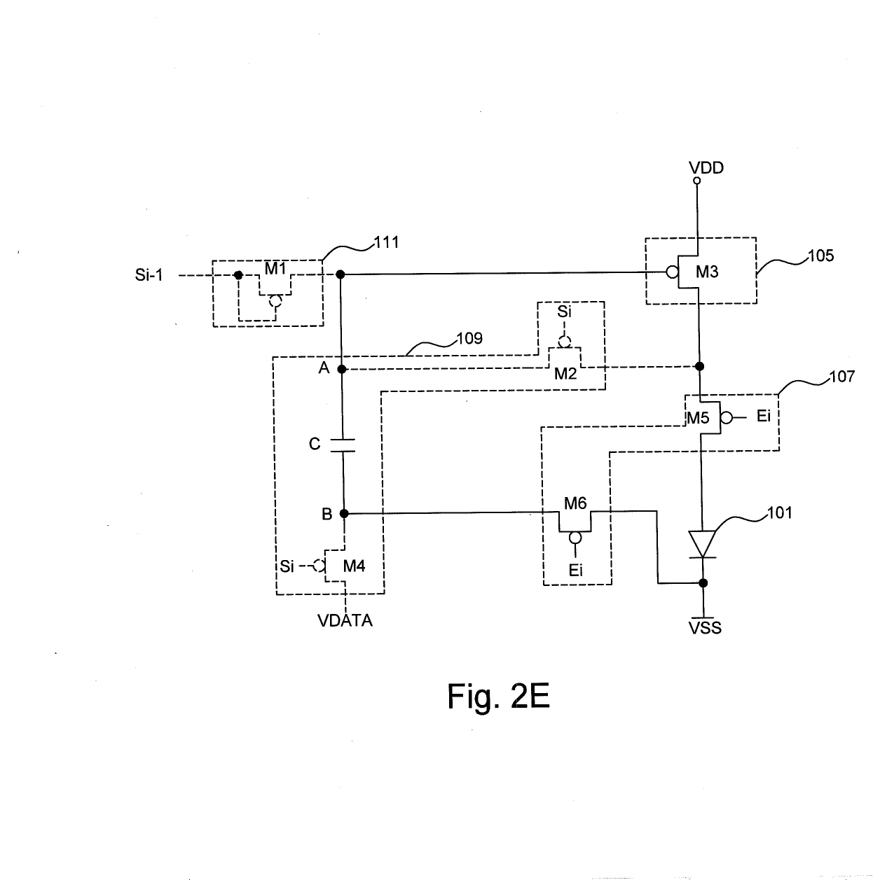

FIG. 1 shows a schematic diagram illustrating an embodiment of a driver circuit 10 for a display device and FIG. 2A shows an exemplary circuit diagram of the driver circuit 10. Referring to FIGS. 1 and 2A, the exemplary embodiment of the driver circuit 10 may be applied to a pixel circuit. The driver circuit 10 includes a light-emitting element 101(such as an OLED (organic light-emitting diode) but not limited) and a light-emitting element driver circuit 103. In an embodiment, the light-emitting element driver circuit 103 includes a driver unit 105, a control unit 107 and a data storage unit 109. In another embodiment, the light-emitting element driver circuit 103 may further include an initial control unit 111.

The driver unit 105 is used to provide the light-emitting element 101 a driving current IOLED.

The data storage unit 109 stores the threshold voltage of the driver unit 105 and a current data signal voltage VDATA.

The control unit 107 is controlled to be conducted during a light emitting period. The driver unit 105 generates the driving current IOLED, in response to a voltage stored in the data storage unit 109 according to the conduction of the control unit 107.

The initial control unit 111 controls the data storage unit 109 to keep its voltage at an initial state of a low voltage level. Thus current data signal voltage can be correctly written into the data storage unit 109 without being affected by previous data signal voltage.

As shown in FIG. 2A, in an embodiment, the light-emitting element 101 included in a pixel circuit may be an OLED (organic light-emitting diode) or other kinds of light-emitting diode. The light-emitting element 101 emits light according to the driving current IOLED.

Specifically to say, referring to FIG. 1 and FIG. 2A, the driver unit 105 includes a driving transistor (second transistor) M3. The data storage unit 109 includes a data writing transistor (third transistor) M4, an acquisition transistor (first transistor) M2 and a capacitor C. The control unit 107 includes an electric drive transistor (fourth transistor) M5 and a control transistor (fifth transistor) M6. In an embodiment, the acquisition transistor M2 of the data storage unit 109 is coupled to the driving transistor M3 of the driver unit 105 to form a diode-connected configuration.

The driving transistor M3 of the driver unit 105 generates the driving current IOLED to the light-emitting element 101 according to the data signal voltage VDATA applied to its gate, wherein the data signal voltage VDATA is received from the data writing transistor M4 and the capacitor C.

The capacitor C of the data storage unit 109 stores the data signal voltage VDATA which is applied to the gate of the driving transistor M3. The data writing transistor M4 of the data storage unit 109 switches the data signal voltage VDATA, applied to the associated data line, in response to current scan line signal Si applied to the associated scan line.

The electric drive transistor M5 of the control unit 107 provides the driving current IOLED, generated through the driving transistor M3, for the light-emitting element 101 in response to current light-emitting signal Ei. The control transistor M6 of the control unit 107 is coupled to a first terminal of the capacitor C to a reference potential terminal VSS, such as a ground terminal, according to current light-emitting signal Ei.

Please note that an embodiment of the acquisition transistor M2 may be a P-type thin film transistor in which current scan signal Si is applied to its gate, its drain and source are respectively coupled to the gate and drain/source of the driving transistor M3 of the driver unit 105.

An embodiment of the driving transistor M3 of the driver unit 105 may be a P-type thin film transistor in which its gate is coupled to the drain of acquisition transistor M2 and a second terminal of the capacitor C to form a node A (first node), its drain is coupled to the light-emitting element 101, and its source is coupled to a power supply voltage VDD from a power supply terminal, wherein the power supply terminal is used to received the power supply voltage VDD.

The second terminal of the capacitor C is coupled to the node A.

An embodiment of the data writing transistor M4 of the data storage unit 109 may be a P-type thin film transistor in which current scan line signal Si, applied to the associated scan line, is applied to its gate, a data signal voltage VDATA, applied to the associated data line, is applied to its drain, and its source is coupled to a first terminal of the capacitor C to form a node B (second node).

An embodiment of the electric drive transistor M5 of the control unit 107 may be a P-type thin film transistor in which current light-emitting signal Ei is applied to its gate, its source is coupled to the drain/source of the driving transistor M3, and its drain is coupled to one terminal of the light-emitting element 101. Another terminal of the light-emitting element 101 is coupled to the reference potential terminal VSS. An embodiment of the control transistor M6 of the control unit 107 may be a P-type thin film transistor in which current light-emitting signal Ei is applied to its gate, its source is coupled to the node B, and its drain is coupled to the reference potential terminal VSS.

An embodiment of the initial control unit 111 includes a reset transistor M1 (sixth transistor). The reset transistor M1 discharges previous data signal voltage, stored in the capacitor C, to initialize a voltage level of the capacitor C according to previous scan line signal, applied to the associated scan line. Thus the capacitor C can be reset. An embodiment of the reset transistor M1 may be a P-type thin film transistor in which previous scan line signal Si-1, applied to the associated scan line, is applied to its source, its gate is coupled to its source, and its drain is coupled to the gate of the driving transistor M3 of the driver unit 105.

An example of operation of the driver circuit 10 according to the present invention is be described with reference to FIGS. 2B to 2E.

First, as shown in FIG. 2B, the light-emitting element driver circuit 103 of the driver circuit 10 includes at least following stage: reset stage I, compensation stage II and electroluminescent stage III.

In the reset stage I, as shown in FIGS. 2A, 2B and 2C, during the reset stage I in which previous scan line signal Si-1 is of a low level, and current scan line signal Si and current light-emitting signal Ei are of a high level, since the acquisition transistor M2 and the data writing transistor M4 of the data storage unit 109 are turned off by the high level of current scan line signal Si, the electric drive transistor M5 and the control transistor M6 of the control unit 107 are turned off by the high level of current light-emitting signal Ei, and the reset transistor M1 of the initial control unit 111 is turned on by the low level of previous scan line signal Si-1, an initialization path (as indicated by a solid line shown in FIG. 2C) is formed.

In the meantime, the capacitor C of the data storage unit 109 discharges its stored voltage from a voltage level of previous data signal voltage to a voltage level of previous scan line signal Si-1 via the reset transistor M1. Thus a voltage level on the node A of the capacitor C becomes the low level of previous scan line signal Si-1 and a voltage level on the node B of the capacitor C remains the voltage of the reference potential terminal VSS of last electroluminescent stage III. Thus the capacitor C can operate in a reset state. Further the gate of the driving transistor M3 of the driver unit 105 is turned on being controlled by previous scan line signal, but the electric drive transistor M5 of the control unit 107 is turned off so that there is no current flowing through the light-emitting element 101.

Next, in the compensation stage II, as shown in FIGS. 2A, 2B and 2D, during the compensation stage II in which previous scan line signal Si-1 and current light-emitting signal Ei are of a high level, and current scan line signal Si is of a low level, the reset transistor M1 of the initial control unit 111 is turned off by the high level of previous scan line signal Si-1, the electric drive transistor M5 and the control transistor M6 of the control unit 107 are turned off by the high level of current light-emitting signal Ei.

Since the acquisition transistor M2 of the data storage unit 109 are turned on by the low level of current scan line signal Si, the acquisition transistor M2 of the data storage unit 109 and the driving transistor M3 of the driver unit 105 are coupled to form a diode-connected configuration. The transistor M4 of the data storage unit 109 are also turned on by the low level of current scan line signal Si. Accordingly, a compensation path (as indicated by a solid line shown in FIG. 2D) is formed.

Please note that, as a result of the data writing transistor M4 of the data storage unit 109 being turned on, the data signal voltage VDATA, applied to associated data line, is provided to the first terminal (node B) of the capacitor C. On the other hand, as indicated by FIG. 2D, since the acquisition transistor M2 of the data storage unit 109 and the driving transistor M3 of the driver unit 105 are coupled to form a diode-connected configuration, a voltage level of the second terminal of the capacitor C (node A) is charged to VDD-Vth, wherein VDD is a power supply voltage, Vth is a threshold voltage of the driving transistor M3. Accordingly, the voltage stored in the capacitor C, which is a difference between the first terminal and the second terminal of the capacitor C, equals to VDD-Vth-VDATA.

In electroluminescent stage III, as shown in FIGS. 2A, 2B and 2E, during the electroluminescent stage III in which previous scan line signal Si-1 and current scan line signal Si are of a high level, and current light-emitting signal Ei is of a low level, since the reset transistor M1 of the initial control unit 111 is turned off by the high level of previous scan line signal Si-1, the acquisition transistor M2 and the data writing transistor M4 of the data storage unit 109 are turned off by the high level of current scan line signal Si, and the electric drive transistor M5 and the control transistor M6 of the control unit 107 are turned on by the low level of current light-emitting signal Ei, a electroluminescent path (as indicated by a solid line shown in FIG. 2E) is formed.

As shown in FIG. 2E, the driving transistor M3 of the driver unit 105 generates driving current IOLED during the electroluminescent stage III and the driving current IOLED flows through the light-emitting element 101 to drive it. The driving current IOLED is represented by the following Expression:

$$\begin{matrix}I O L E D = {K ( Vsg - Vth )}^{2} \\ = {K ( Vs - Vg - Vth )}^{2} \\ = {K ( VDD - ( VDD - Vth - VDATA ) - Vth )}^{2} \\ = {K ( VDATA )}^{2}\end{matrix}$$

Where, K represents transconductance of the driving transistor M3, Vsg represents a source-to-gate voltage of the driving transistor M3, and Vs represents a source voltage of the driving transistor M3 here indicated as a power supply voltage VDD, Vg represents a voltage applied to the gate of the driving transistor M3.

Since the first terminal (node B) of the capacitor C is coupled to a low voltage level of the reference potential terminal VSS, such as a ground potential, due to the control transistor M6 being turned on, a voltage level of the second terminal (node A) of the capacitor C is increased to VDD-Vth-VDATA. Therefore, the driving current IOLED is only related to a square of the data signal voltage VDATA (K(VDATA)²) but not related to a threshold voltage Vth of the driving transistor M3 of the driver unit 105. As a result, the present invention can solve problem of threshold voltage variation of the driving transistor M3, and compensate power delivery IR drop through a flow path of the driving current IOLED.

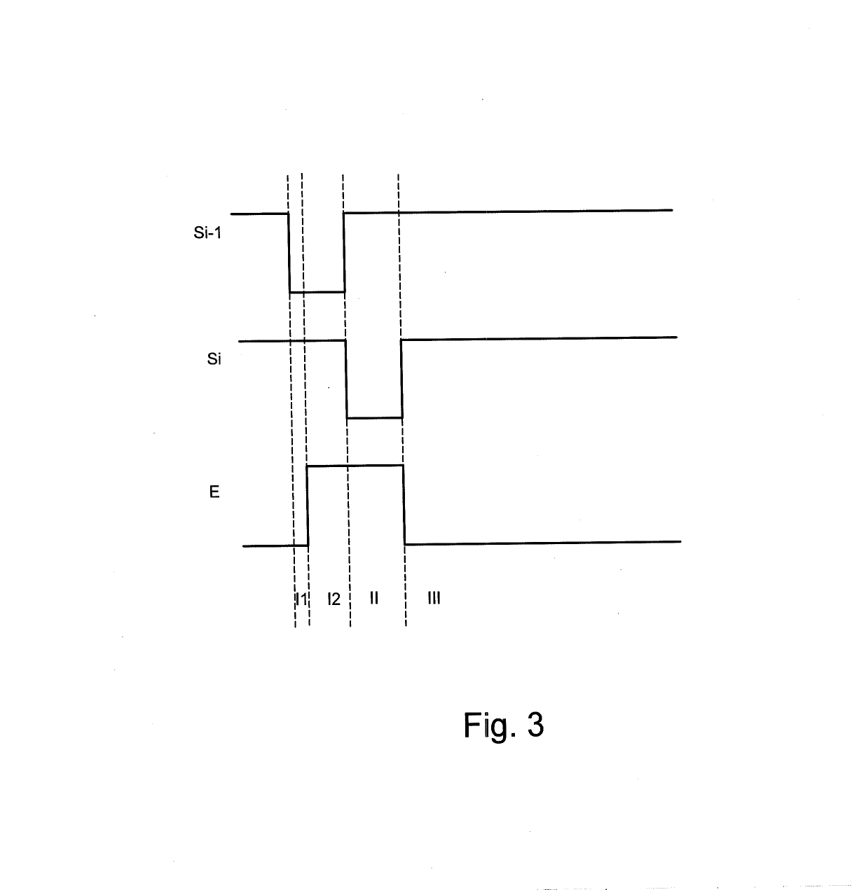

An embodiment, as shown in FIG. 3, the light-emitting element driver circuit 103 of the driver circuit 10 of the invention may further separate the reset stage I into a first reset stage I1 and a second reset stage I2.

Referring to FIGS. 2A and 3, in the first reset stage I1, since current light-emitting signal Ei is of a low level, the control transistor M6 of the control unit 107 is turned on. Therefore, the first terminal (node B) of the capacitor C of the data storage unit 109 is insured to be the low voltage level of the reference potential terminal VSS so that the voltage of the capacitor C of the data storage unit 109 can be discharged completely without remaining any charge for stabilizing operation of the light-emitting element driver circuit 103.

In the second reset stage 12, since current light-emitting signal Ei is changed into a high level, the control transistor M6 of the control unit 107 is turned off. Also, the reset transistor M1 of the initial control unit 111 is turned on by a low level of previous scan line signal Si-I. Thus a voltage level of the capacitor C is pulled to a voltage level of previous scan line signal Si-1. Please note that, in this embodiment, operation of following stages for the light-emitting element driver circuit 103 is the same as operation of FIGS. 2B-2E and thus it will not be described hereinafter.

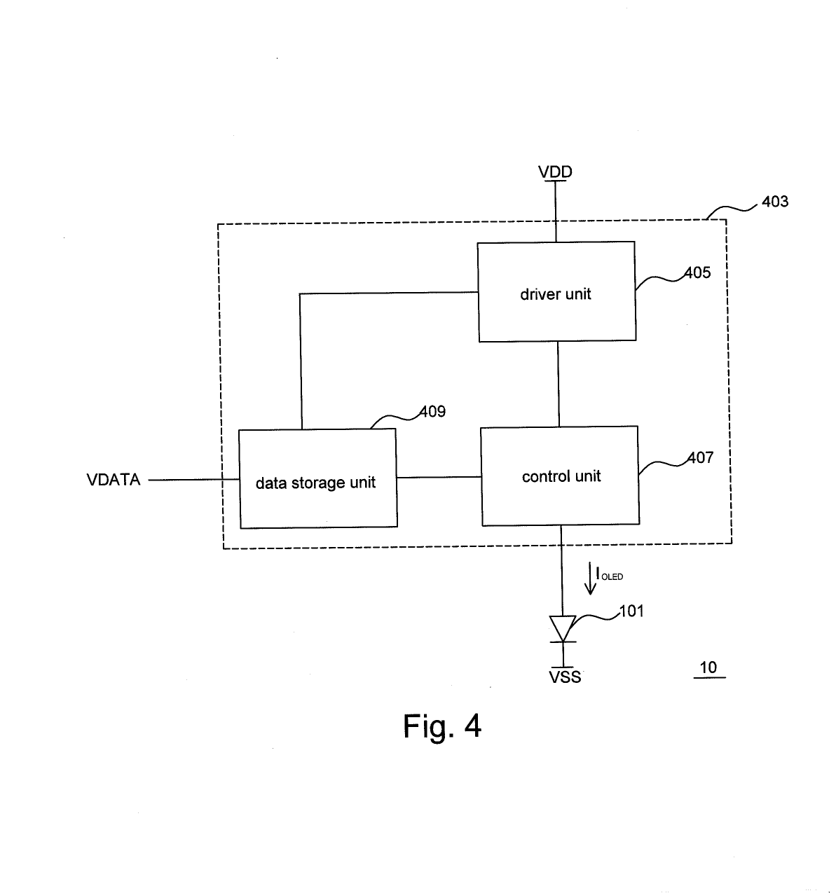

FIG. 4 shows a schematic diagram illustrating an embodiment of a light-emitting element driver circuit 403. The architecture of the light-emitting element driver circuit 403 is shown in the FIG. 4 and will not be described. The operation of the light-emitting element driver circuit 403 is approximately the same as the light-emitting element driver circuit 103 shown in FIG. 1. A difference of them is that the light-emitting element driver circuit 403 omits the initial control unit 111. In this architecture, the light-emitting element driver circuit 403 can still reach functions of eliminating threshold voltage variation of the driver unit 405 and compensating power delivery IR drop through a flow path of the driving current IOLED.

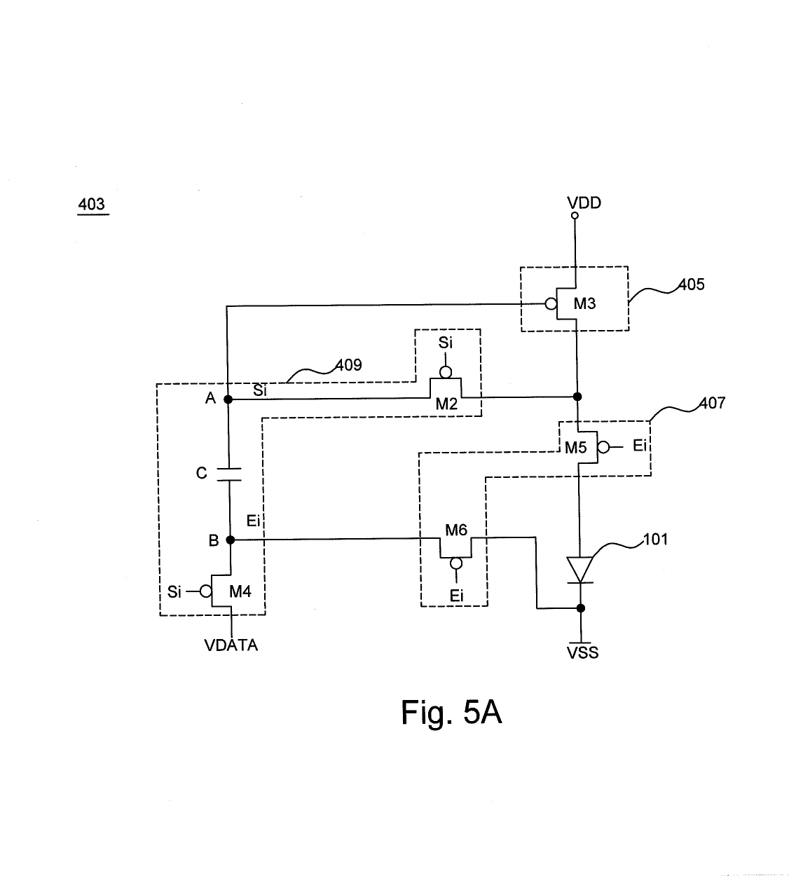

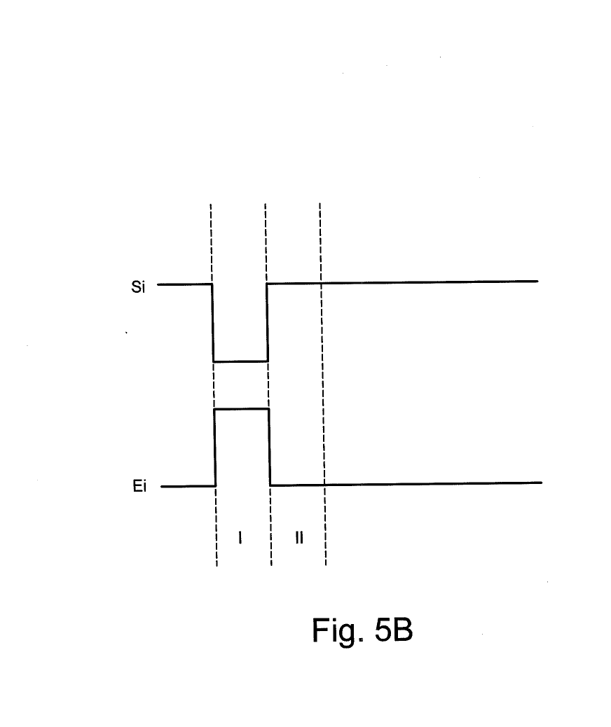

FIG. 5A shows an exemplary circuit of the light-emitting element driver circuit 403 of FIG. 4. In FIG. 5A, the reset transistor M1 of the initial control unit 111 is omitted. As shown in FIG. 5B, operation of the light-emitting element driver circuit 403 may include two stages: a compensation stage I and an electroluminescent stage II. A skilled in the art can realize operation of this circuit according to waves of previous scan line signal Si-1, current scan line signal Si and current light-emitting signal Ei shown in FIG. 3B and above description. Thus it will not be described hereinafter.

Please note that embodiments of the invention may use five transistors and a capacitor to implement, but the invention is not limited here. Further embodiments of the light-emitting element driver circuit use PMOS as main elements, but the invention is not limited here. The invention of the light-emitting element driver circuit may use other semiconductor element, transistor, such as NMOS transistor, CMOS transistor, etc., to implement functions of the invention.

Although specific embodiments have been illustrated and described herein, it will be appreciated by those of ordinary skill in the art that any arrangement that is calculated to achieve the same purpose may be substituted for the specific embodiments shown. This application is intended to cover adaptations and variations of the embodiments discussed herein. Various embodiments use permutations and/or combinations of embodiments described herein. It is to be understood that the above description is intended to be illustrative, and not restrictive, and that the phraseology or terminology employed herein is for the purpose of description.

What is claimed is:

1. A light-emitting element driver circuit, comprising:
a driver unit for generating a driving current to the light-emitting element;
a data storage unit for storing a threshold voltage of the driver unit and a current data signal voltage; and
a control unit being controlled to be conducted during a light emitting period so that the driver unit generates a driving current in response to the threshold voltage and the current data signal voltage stored in the data storage unit.

2. The circuit according to claim 1, further comprising:
an initial control unit, wherein the initial control unit is used for controlling the data storage unit to remain a voltage of the data storage unit at an initial state of a low voltage level and insure the current data signal voltage is correctly written into the data storage unit without being affected by previous data signal voltage.

3. The circuit according to claim 1, wherein the driver unit comprises a driving transistor and the driving transistor is used for generating the driving current to the light-emitting element according to the data signal voltage from the data storage unit.

4. The circuit according to claim 3, wherein the data storage unit comprises:
a capacitor, for storing the data signal voltage applied to the driver unit and the threshold voltage of the driving transistor;
a data writing transistor for applying the data signal voltage to a first terminal of the capacitor, in response to a current scan line signal; and
an acquisition transistor coupled to the driving transistor to form a diode-connected configuration;
wherein, when the acquisition transistor is turned on by the current scan line signal, the threshold voltage of the driving transistor is applied to a second terminal of the capacitor.

5. The circuit according to claim 4, wherein the control unit comprises:
an electric drive transistor for providing the driving current to the light-emitting element, in response to a current light-emitting signal; and
a control transistor for coupling the first terminal of the capacitor to a reference potential terminal according to the current light-emitting signal.

6. A light-emitting element driver circuit, comprising:
a light-emitting element, wherein a driving current flows through the light-emitting element;
a first transistor being controlled by a first scan line signal;
a second transistor being controlled by a data signal voltage to generate the driving current;
a capacitor for storing the data signal voltage and a threshold voltage of the second transistor;
a third transistor being controlled by a second scan line signal to receive the data signal voltage and apply the data signal voltage to a first terminal of the capacitor;
a fourth transistor being controlled by a first light-emitting signal to supply the driving current of the second transistor to the light-emitting element; and
a fifth transistor being controlled by a second light-emitting signal to couple the first terminal of the capacitor to a ground potential;
wherein the first transistor applies the threshold voltage of the second transistor to a second terminal of the capacitor according to the first scan line signal, and the first transistor is coupled to the second transistor to form a diode-connected configuration to detect deviation of the threshold voltage of the second transistor.

7. The circuit according to claim 6, further comprising a sixth transistor for resetting a voltage level of the capacitor.

8. The circuit according to claim 7, wherein a method for resetting a voltage of the capacitor comprises:
a first reset stage for setting the second light-emitting signal to a low level and controlling the fifth transistor to be turned on so that the capacitor is coupled to a reference potential; and
a second reset stage for setting the second light emitting signal to a high level, and controlling the fifth transistor to be turned off and the sixth transistor to be turned on so that a voltage of the capacitor is pulled to a preset voltage level.

9. The circuit according to claim 6, wherein the first scan line signal and the second scan line signal are current scan line signals.

10. The circuit according to claim 9, wherein the first light-emitting signal and the second light-emitting signal are current light-emitting signals.

11. The circuit according to claim 6, wherein the first transistor is a P-type thin film transistor in which the first scan line signal is applied to the gate of the first transistor, the drain of the first transistor is coupled to the gate of the second transistor, and the source of the first transistor is coupled to the drain of the second transistor.

12. The circuit according to claim 6, wherein the second transistor is a P-type thin film transistor in which the gate of the second transistor is coupled to the drain of the first transistor to form a first node, the drain of the second transistor is coupled to the light-emitting element, and the source of the second transistor is coupled to a power supply voltage.

13. The circuit according to claim 12, wherein the second terminal of the capacitor is coupled to the first node, the third transistor is a P-type thin film transistor in which the second scan line signal is applied to the gate of the third transistor, a data signal voltage is applied to the drain of the third transistor, and the source of the third transistor is coupled to the first terminal of the capacitor to form a second node.

14. A light-emitting element driver circuit, comprising:
a power supply terminal for receiving a power supply voltage;
a light-emitting element, wherein a driving current flows through the light-emitting element;
a first transistor being controlled by a first scan line signal;
a second transistor coupled to the first transistor to form a diode-connected configuration, wherein the second transistor comprises a threshold voltage and receives a voltage difference value;
a capacitor, comprising a first terminal and a second terminal and storing the voltage difference value between the first terminal and the second terminal;
a third transistor being controlled by a second scan line signal to receive the data signal voltage and apply the data signal voltage to the first terminal;
a fourth transistor being controlled by a first light-emitting signal to supply the driving current to the light-emitting element; and
a fifth transistor being controlled by a second light-emitting signal to couple the first terminal to a ground potential;
wherein the first transistor applies the threshold voltage to the second terminal according to the first scan line signal, and the second transistor generates the driving current according to the voltage difference value and the voltage difference value compensates deviation of the threshold voltage of the second transistor.

15. The circuit according to claim 14, wherein the voltage difference value equals to a value of subtracting the threshold voltage and the data signal voltage from the power supply voltage.

16. The circuit according to claim 14, wherein the first scan line signal and the second scan line signal are current scan line signals.

17. The circuit according to claim 16, wherein the first light-emitting signal and the second light emitting signal are current light-emitting signals.

18. The circuit according to claim 14, wherein the first transistor is a P-type thin film transistor in which first scan line signal is applied to the gate of the first transistor, the drain of the first transistor is coupled to the gate of the second transistor, and the source of the first transistor is coupled to the drain of the second transistor.

19. The circuit according to claim 14, wherein the second transistor is a P-type thin film transistor in which the gate of the second transistor is coupled to the drain of the first transistor to form a first node, the drain of the second transistor is coupled to the light-emitting element, and the source of the second transistor is coupled to a power supply voltage.

20. The circuit according to claim 19, wherein the second terminal of the capacitor is coupled to the first node, the third transistor is a P-type thin film transistor in which the second scan line signal is applied to the gate of the third transistor, a data signal voltage is applied to the drain of the third transistor, and the source of the third transistor is coupled to the first terminal of the capacitor C to form a second node.

21. A display device, comprising:
a plurality of gate lines; a plurality of data lines; a plurality of power lines; and a plurality of pixels each arranged in an associated gate line, data line and power line; each pixel comprising:
a first transistor being controlled by a first scan line signal;
a second transistor being controlled by a data signal voltage to generate the driving current, wherein the second transistor couples to the first transistor to form a diode-connected configuration;
a capacitor for storing the data signal voltage;
a third transistor, being controlled by a second scan line signal to receive the data signal voltage to apply the data signal voltage to a first terminal of the capacitor;
a fourth transistor being controlled by a first light-emitting signal to supply the driving current of the second transistor to an organic light-emitting diode; and
a fifth transistor being controlled by a second light-emitting signal to couple the first terminal of the capacitor to a ground potential;
wherein the first transistor applies the threshold voltage of the second transistor to a second terminal of the capacitor according to the first scan line signal, and the driving current generated by the second transistor is not related to the threshold voltage of the second transistor.
